(19) United States
(12) Patent Application Publication
(10) Pub. No.: US 2026/0061735 A1
(43) Pub. Date: Mar. 5, 2026

(54) DEFORMATION-CONTROLLING FILM AND METHOD OF CONTROLLING DEFORMATION OF SHEET

(71) Applicants: Cian-Tong LU, Hsinchu County (TW); Li-Chuan SU, Hsinchu County (TW)

(72) Inventors: Cian-Tong LU, Hsinchu County (TW); Li-Chuan SU, Hsinchu County (TW)

(21) Appl. No.: 19/289,122

(22) Filed: Aug. 4, 2025

(30) Foreign Application Priority Data
Aug. 29, 2024 (TW) 113132597

(51) Int. Cl. B32B 37/10; B32B 3/30

(52) U.S. Cl. CPC B32B 37/1018; B32B 2307/536; B32B 2307/542; B32B 2307/7376; B32B 2383/00

(57) ABSTRACT

A deformation-controlling film includes a protective layer and a deformation-controlling layer. The deformation-controlling layer is connected to the protective layer, and a surface of the deformation-controlling layer away from the protective layer has an adhering structure. The adhering structure includes a plurality of bumps. The plurality of bumps protrudes from the surface of the deformation-controlling layer in a direction away from the protective layer, and an air-leaving channel is formed between adjacent two of the plurality of bumps.

### RELATED APPLICATIONS

This application claims priority to Taiwan Application Serial Number 113132597, filed Aug. 29, 2024, which is herein incorporated by reference.

### BACKGROUND

### Technical Field

The present disclosure relates to a deformation-controlling film and a method of controlling deformation of a sheet. More particularly, the present disclosure relates to a deformation-controlling film adhered to a sheet in a physical way and a method of controlling deformation of the sheet.

### Description of Related Art

In the current semiconductor advanced packaging technology, especially in the fan-out wafer level packaging (FOWLP) or fan-out panel level packaging (FOPLP) process, in order to prevent wafer or substrate material with silicon and ceramic components (such as SiO₂, Si, SiC, GaN, Al₂O₃ and other materials) from deforming due to material stress changing during such processes as punching, rewiring, thin film deposition, thinning and thermal tempering, the wafers or the substrate need to be pre-adhered to hard glasses or silicon wafer carriers to maintain the original rigidity of the wafer or the substrate and reduce the deformation problem in the process.

However, the defect of the aforementioned method is that the wafer or the substrate needs to be coated with colloid or tape before being adhered to the carrier. After the process is completed, the colloid or the tape must be removed by mechanical, laser irradiation, solvent dissolution, heating or other methods to separate the wafer or the substrate from the carrier. In the adhesion process and separate process, not only massive product materials and product costs are needed, but also expensive high-precision alignment adhering machine is required, and after the manufacturing process, separation should also be done by separator equipment. Thus, in the manufacturing process, not only more waste is generated, but also a large amount of electricity is consumed, which significantly increases the carbon footprint of the product, which is not conducive to ESG sustainable development.

Taiwan holds a leading position in the global wafer industry, and the advancement of technology development and application is the key to maintaining competitiveness. However, existing processes are complex and energy-intensive, which runs counter to the global ESG low-carbon goals. In the face of this challenge, innovation in material development and structural design, especially the development of deformation control methods and products has the potential to bring significant changes to wafer processing, thereby achieving a more low-carbon and environmentally friendly wafer manufacturing process while maintaining technological leadership. In view of this, how to reduce wafer or substrate deformation under the premise of process simplification and production cost reduction has become the goal that related industries strive for.

### SUMMARY

According to one embodiment of the present disclosure, a deformation-controlling film a includes protective layer and a deformation-controlling layer. The deformation-controlling layer is connected to the protective layer, and a surface of the deformation-controlling layer away from the protective layer has an adhering structure. The adhering structure includes a plurality of bumps. The plurality of bumps protrudes from the surface of the deformation-controlling layer in a direction away from the protective layer, and an air-leaving channel is formed between adjacent two of the plurality of bumps.

According to another embodiment of the present disclosure, a method of controlling deformation of a sheet includes the following steps. A deformation-controlling film is made be contacted with the sheet. A gas between the deformation-controlling film and the sheet is made be exhausted to form a temporary bonding, so as to control a warpage degree of the sheet. The deformation-controlling film includes a protective layer and a deformation-controlling layer, the deformation-controlling layer is connected to the protective layer, a surface of the deformation-controlling layer away from the protective layer has an adhering structure, and the deformation-controlling film is contacted with the sheet by the adhering structure. The adhering structure includes a plurality of bumps, the plurality of bumps protrude from the surface of the deformation-controlling layer in a direction away from the protective layer, an air-leaving channel is formed between adjacent two of the plurality of bumps, and the gas is exhausted by the air-leaving channel.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional schematic view of a deformation-controlling film according to the 1st example of an embodiment of the present disclosure.

FIG. 2A is a cross-sectional schematic view of the deformation-controlling film along a line 2A-2A according to FIG. 1.

FIG. 2B is an enlarged schematic view of a position 2B of the deformation-controlling film according to FIG. 2A.

FIG. 3A is a partial schematic view of an adhering structure of the deformation-controlling film according to the 1st example of the present disclosure.

FIG. 3B is a partial schematic view of an adhering structure of the deformation-controlling film according to the 2nd example of the present disclosure.

FIG. 3C is a partial schematic view of an adhering structure of the deformation-controlling film according to the 3rd example of the present disclosure.

FIG. 3D is a partial schematic view of an adhering structure of the deformation-controlling film according to the 4th example of the present disclosure.

FIG. 3E is a partial schematic view of an adhering structure of the deformation-controlling film according to the 5th example of the present disclosure.

FIG. 3F is a partial schematic view of an adhering structure of the deformation-controlling film according to the 6th example of the present disclosure.

FIG. 3G is a partial schematic view of an adhering structure of the deformation-controlling film according to the 7th example of the present disclosure.

FIG. 4 is a step flowchart of a method of controlling deformation of a sheet according to another embodiment of the present disclosure.

FIG. 5A, FIG. 5B and FIG. 5C are structural schematic views of each of steps of the method of controlling deformation of the sheet, respectively.

### DETAILED DESCRIPTION

Each of embodiments of the present disclosure will be described below with reference to the accompanying drawings. The following description will include many practical details in order to be clear and specific. The reader, however, should understand that those practical details are not intended to be restrictive of the scope of the invention; in other words, the practical details are not essential to some embodiments of the invention. Besides, for the sake of simplicity of the drawings, some conventional or commonly used structures and elements are drawn only schematically in the drawings.

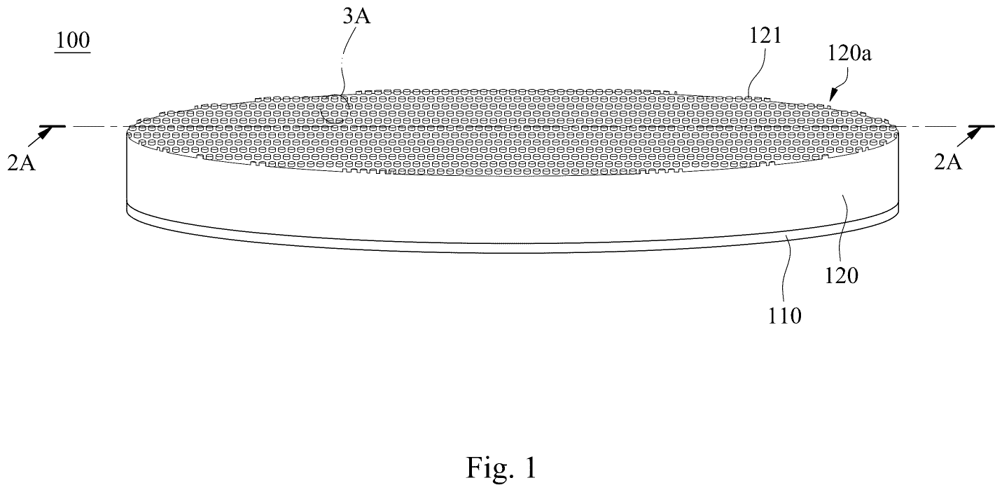

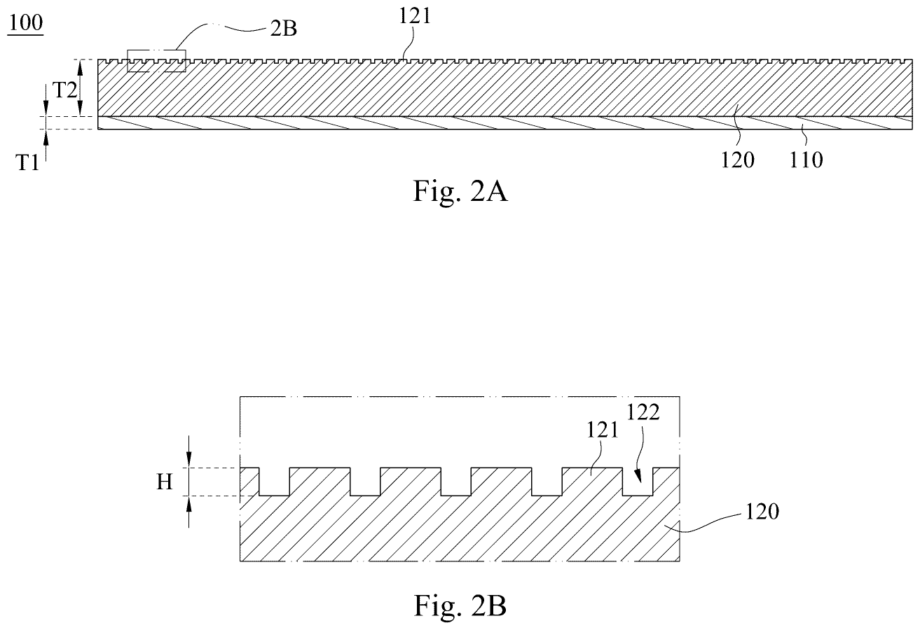

Please refer to FIG. 1 and FIG. 2A. FIG. 1 is a three-dimensional schematic view of a deformation-controlling film 100 according to the 1st example of an embodiment of the present disclosure. FIG. 2A is a cross-sectional schematic view of the deformation-controlling film 100 along a line 2A-2A according to FIG. 1. The deformation-controlling film 100 includes a protective layer 110 and a deformation-controlling layer 120. The deformation-controlling layer 120 is connected to the protective layer 110.

In detail, a material of the protective layer 110 can include polyester or other polymers with stability, for example, the material can be selected from a group consisting of polyimide (PI) and polyethylene naphthalate (PEN). Besides, a thickness T1 of the protective layer 110 can be 50 μm to 500 μm. Alternatively, the thickness T1 of the protective layer 110 can be 60 μm to 250 μm. Alternatively, the thickness T1 of the protective layer 110 can be 75 μm to 125 μm. Therefore, the protective layer 110 is mainly used to provide acid resistance, alkali resistance, heat resistance and other properties to protect the deformation-controlling layer 120.

A surface 120a of the deformation-controlling layer 120 away from the protective layer 110 has an adhering structure (unnumbered). The adhering structure includes a plurality of bumps 121, the plurality of bumps 121 protrude from the surface 120a of the deformation-controlling layer 120 in a direction away from the protective layer 110, and an air-leaving channel 122 is formed between adjacent two of the plurality of bumps 121. The surface 120a of the deformation-controlling layer 120 has the nanospheres, nano-sized suction cups or other structures, which can be directly attached to a sheet to create adhesive force, so as to control the degree of the deformation of the sheet. When the deformation-controlling layer 120 is attached to the sheet, the adhering structure of the deformation-controlling layer 120 can be attached well to the sheet, and the air-leaving channel 122 helps to exhaust the gas between the deformation-controlling layer 120 and the sheet, which further increases the firmness of the adhesion between the deformation-controlling layer 120 and the sheet.

A material of the deformation-controlling layer 120 can include silicone, silicone rubber, epoxy resin, polyurethane, acrylic resin, polyimide or others. The deformation-controlling layer 120 can include an organopolysiloxane composition, a cross-linking agent and an enhanced agent. Based on a total weight of the deformation-controlling layer 120 is 100%, a weight percentage of the organopolysiloxane composition in the deformation-controlling layer 120 can be 30% to 80%, a weight percentage of the cross-linking agent in the deformation-controlling layer 120 can be 18% to 60%, and a weight percentage of the enhanced agent in the deformation-controlling layer 120 can be 1% to 10%. The organopolysiloxane composition can be polymerized through by the cross-linking agent to form the deformation-controlling layer 120, and the enhanced agent can be used to adjust the mechanical properties of the deformation-controlling layer 120.

Furthermore, a monomer of the organopolysiloxane composition can be selected from a group consisting of dimethoxydimethylsilane, triethoxyvinylsilane and trimethoxyphenylsilane. The cross-linking agent can be selected from a group consisting of benzoyl peroxide, 2,4-dichlorobenzoyl peroxide, dicumyl peroxide and 2,5-bis(tert-butylperoxy)-2,5-dimethylhexane. The enhanced agent can be selected from a group consisting of silicon dioxide and silicon carbide. By adjusting the material and the ratio of the deformation-controlling layer 120, the hardness of the deformation-controlling layer 120 can be changed, the shearing force or the friction between the deformation-controlling layer 120 and the sheet can be changed, and heat resistance of the deformation-controlling layer 120 can increase. In addition, the deformation-controlling layer 120 can further maintain the rigidity and the toughness by adding the enhanced agent, which provides better deformation-controlling property.

In detail, the organopolysiloxane composition can form three-dimensional cross-linked network structure through the polymerization by the cross-linking agent. When the deformation-controlling layer 120 is subjected to tension, molecular chains between cross-linked points can be stretched. The enhanced agent of the cross-linked structure can help to maintain the hardness of the deformation-controlling layer 120, which makes the deformation-controlling layer 120 has good tensile strength and mechanical strength at the same time.

A ratio between the thickness T1 of the protective layer 110 and a thickness T2 of the deformation-controlling layer 120 can be 1:0.1 to 1:100. Alternatively, the ratio between the thickness T1 of the protective layer 110 and the thickness T2 of the deformation-controlling layer 120 can be 1:0.2 to 1:72. Alternatively, the ratio between the thickness T1 of the protective layer 110 and the thickness T2 of the deformation-controlling layer 120 can be 1:1 to 1:15. Alternatively, the ratio between the thickness T1 of the protective layer 110 and the thickness T2 of the deformation-controlling layer 120 can be 1:1 to 1:10. The thickness T2 of the deformation-controlling layer 120 can be 50 μm to 5000 μm. Alternatively, the thickness T2 of the deformation-controlling layer 120 can be 500 μm to 3600 μm. Alternatively, the thickness T2 of the deformation-controlling layer 120 can be 1500 μm to 1800 μm. A Shore hardness of the deformation-controlling layer 120 can be 5 A to 50 A. Therefore, the thickness T2, the ratio and the hardness of the deformation-controlling film 100 can be adjusted according to the type of the sheet and degree of deformation, so as to provide different attachment capabilities and supporting forces.

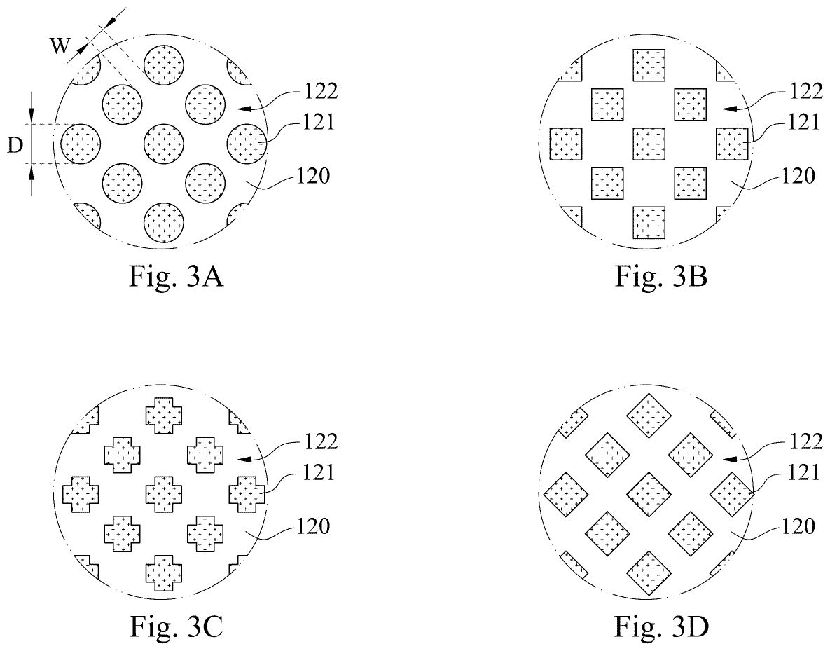

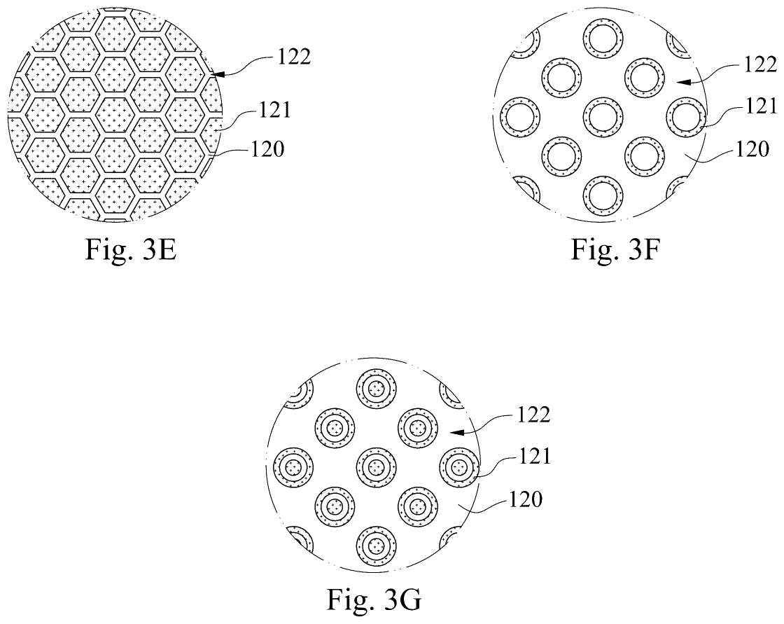

Please refer to FIG. 2B and FIG. 3A. FIG. 2B is an enlarged schematic view of a position 2B of the deformation-controlling film 100 according to FIG. 2A. FIG. 3A is a partial schematic view of an adhering structure of the deformation-controlling film 100 according to the 1st example of the present disclosure, which is an enlarged schematic view of a position 3A of the deformation-controlling film 100 in FIG. 1. The bumps 121 of the adhering structure can be arranged in a staggered way, and a cross-sectional shape of each of the bumps 121 can be a solid circle. A cross-sectional diameter D of each of the bumps 121 can be 1.0 mm to 3.0 mm. A height H of each of the bumps 121 can be 0.1 mm to 0.3 mm. A width W of the air-leaving channel 122 can be 0.2 mm to 1.5 mm. Therefore, the contact area between the deformation-controlling layer 120 and the sheet and the size of the air-leaving channel 122 can be adjusted according to requirements, so as to obtain the most appropriate attachment capabilities and exhaust effect.

Please refer to the FIG. 3B to FIG. 3G. FIG. 3B is a partial schematic view of an adhering structure of the deformation-controlling film 100 according to the 2nd example of the present disclosure. FIG. 3C is a partial schematic view of an adhering structure of the deformation-controlling film 100 according to the 3rd example of the present disclosure. FIG. 3D is a partial schematic view of an adhering structure of the deformation-controlling film 100 according to the 4th example of the present disclosure. FIG. 3E is a partial schematic view of an adhering structure of the deformation-controlling film 100 according to the 5th example of the present disclosure. FIG. 3F is a partial schematic view of an adhering structure of the deformation-controlling film 100 according to the 6th example of the present disclosure. FIG. 3G is a partial schematic view of an adhering structure of the deformation-controlling film 100 according to the 7th example of the present disclosure. The 2nd example to the 7th example of the present disclosure is similar to the aforementioned 1st example, the difference is that the cross-sectional shape of each of the bumps 121 of the 2nd example to the 7th example is respectively a rectangle, a cross, a rhombus, a hexagon, a hollow circle or a concentric circle, and the bumps 121 may have the size such as the 1st example. The cross-sectional diameter D of the bumps 121 is the distance between the two farthest points in the cross-sectional shape. The aforementioned cross-sectional shape will affect the shear force between the deformation-controlling layer 120 and the sheet. Therefore, the bumps 121 can adopt different cross-sectional shape according to the type of the sheet and degree of deformation, so as to obtain the most appropriate attachment capabilities and supporting forces.

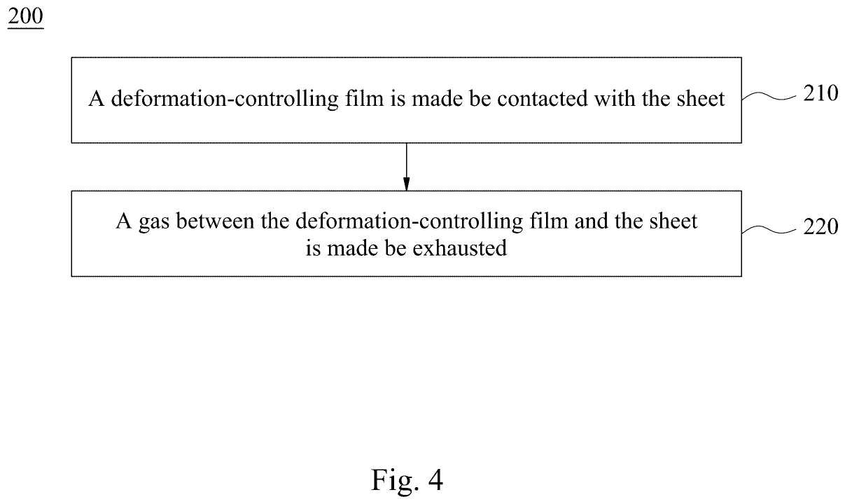

Please refer to FIG. 4. FIG. 4 is a step flowchart of a method of controlling deformation of a sheet 200 according to another embodiment of the present disclosure. Another embodiment of the present disclosure provides the method of controlling deformation of the sheet 200, which includes Step 210 and Step 220.

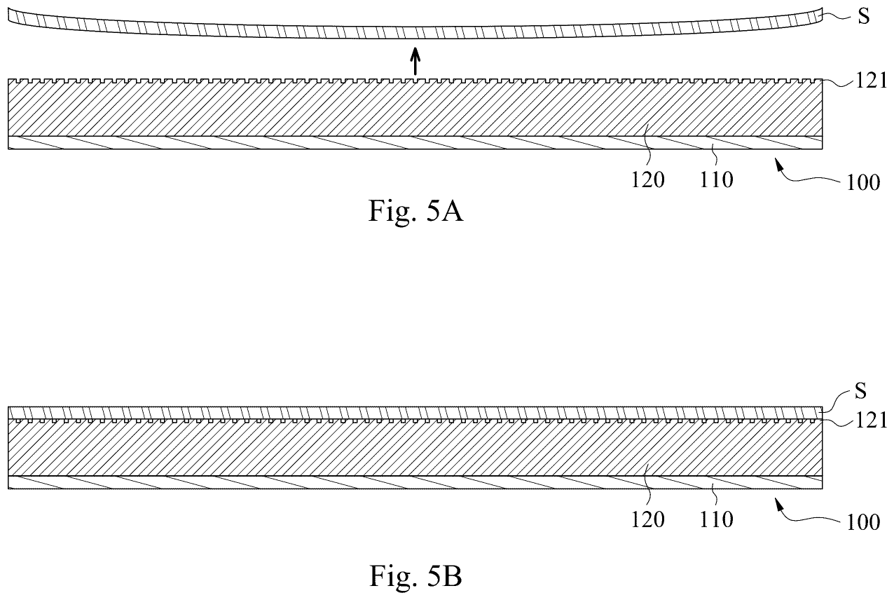

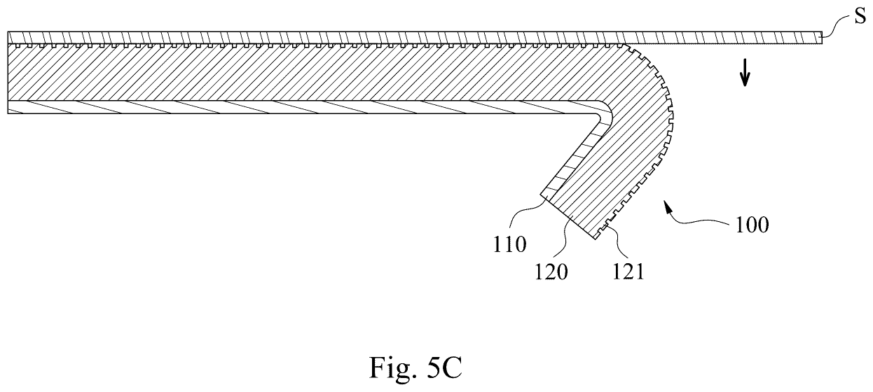

Please refer to FIG. 5A to FIG. 5C. FIG. 5A, FIG. 5B and FIG. 5C are structural schematic views of each of steps of the method of controlling deformation of the sheet 200, respectively. As shown in FIG. 5A, Step 210 is to make a deformation-controlling film 100 be contacted with a sheet S. The material of the sheet S can include SiC, GaN, Al₂O₃, Si or elastic polymer (e.g., polyolefin or polyester, such as polyethylene, polyvinyl chloride, polyethylene naphthalate, polyimide or polyurethane), or the sheet S can be a glass substrate, a carrier, a printed circuit board, an ABF (Ajinomoto build-up film) substrate, a BT (bismaleimide triazine) substrate, a interposer or others materials. However, the material or type of the sheet S of the present disclosure are not limited thereto.

The deformation-controlling film 100 is contacted with the sheet S through the adhering structure. The detail structure of the deformation-controlling film 100 is mentioned in the previous paragraphs, so the detail will not be repeated again herein. A contact area ratio between the adhering structure and a surface of the sheet S can be 40% to 80%, which is a percentage of a contact area between the adhering structure and the sheet S in an overlapping area between the deformation-controlling film 100 and the sheet S, thereby achieving a good attachment effect.

Next, as shown in FIG. 5B, Step 220 is to make a gas between the deformation-controlling film 100 and the sheet S be exhausted to form a temporary bonding, so as to control a warpage degree of the sheet S. The gas is exhausted from the air-leaving channel 122 of the deformation-controlling film 100, thereby improving the attachment effect between the deformation-controlling film 100 and the sheet S.

It should be specifically noted that, according to the method of controlling deformation of the sheet 200 in the present disclosure, the degree of deformation of the sheet S is controlled by the interaction between a shear force between the protective layer 110 and the deformation-controlling layer 120, and the other shear force between the deformation-controlling layer 120 and the sheet S. As shown in FIG. 5B, the direction of the shear force between the protective layer 110 and the deformation-controlling layer 120 can be into the plane of the figure, while the direction of the shear force between the deformation-controlling layer 120 and the sheet S can be out of the plane of the figure, and the shear force between the protective layer 110 and the deformation-controlling layer 120 should be bigger than the shear force between the deformation-controlling layer 120 and the sheet S. In coordination with the mechanical property of the deformation-controlling layer 120, enough tensile strength to control the deformation of the sheet S can be provided. The shear force between the deformation-controlling film 100 and the sheet S can be 39 g/mm to 283 g/mm, which is the force of the deformation-controlling film 100 and the sheet S respectively moved in opposite directions. Therefore, the effect of controlling the deformation of the sheet S can be achieved.

Moreover, a peeling force between the deformation-controlling film 100 and the sheet S can be 0.4 g/mm to 3.7 g/mm, which is the force to peel the deformation-controlling film 100 from one side in the direction perpendicular to the sheet S. Therefore, the good attachment effect between the deformation-controlling film 100 and the sheet S can be ensured.

Moreover, the warpage degree of the sheet S can be 10 mm to 100 mm, which is measured by placing the sheet S on a horizontal surface and testing the vertical distance from the edge of the sheet S to the horizontal surface. Consequently, the method of controlling deformation of the sheet 200 of the present disclosure can effectively control the deformation of the sheet S.

After the deformation of the sheet S is under control, the sheet S can be processed. When the processing is completed, the deformation-controlling film 100 is removed as shown in FIG. 5C. Because the deformation-controlling film 100 is attached to the sheet S by physical adhesion, the deformation-controlling film 100 can be separated simply by using tools such as clamps or adhesive tape to peel the deformation-controlling film 100 off from the sheet S surface. There is no need of machine, laser irradiation, solvent dissolution, or heating to separate the deformation-controlling film 100 from the sheet S. Therefore, the process steps can be simplified, and production costs can be reduced.

The following specific examples are provided to further illustrate the present disclosure, so as to contribute to person having ordinary skill in the art of the present disclosure to fully understand and implement the present disclosure without undue interpretation. However, these examples should not be considered as limiting the scope of the present disclosure, but be used to explaining the materials and methods of the present disclosure.

<Adhesion and Support Effects of Bumps with Different Shapes and Sizes>

Please refer to FIG. 3A to FIG. 3G. The following paragraphs describe the measurement of shear forces for the deformation-controlling films in the 1st example to the 21st example, in order to understand the adhesion effect between the deformation-controlling films and the sheets in the 1st example to the 21st example. The measured area of the experiments is 20 mm×20 mm. The shear force is measured by pulling the deformation-controlling films and the sheets in opposite directions. The detail measurement results are shown in Table 1.

TABLE 1

| | 1st | 2nd | 3rd | 4th | 5th | 6th | 7th |
|---|---|---|---|---|---|---|---|
| | example | example | example | example | example | example | example |
| cross-sectional | solid | rectangle | cross | rhombus | hexagon | hollow | concentric |
| shape of the bumps | circle | | | | | circle | circle |
| cross-sectional | 1.25 | 1.25 | 1.25 | 1.25 | 1.25 | 1.25 | 1.25 |
| diameter of the | | | | | | | |
| bumps (mm) | | | | | | | |
| height of the | 0.25 | 0.25 | 0.25 | 0.25 | 0.25 | 0.25 | 0.25 |
| bumps (mm) | | | | | | | |
| width of the air- | 0.5 | 0.5 | 0.5 | 0.5 | 0.5 | 0.5 | 0.5 |
| leaving channel (mm) | | | | | | | |
| shear force (g/mm) | 70 | 49 | 53 | 78 | 87 | 81 | 89 |
| | 8th | 9th | 10th | 11th | 12th | 13th | 14th |
| | example | example | example | example | example | example | example |
| cross-sectional | solid | rectangle | cross | rhombus | hexagon | hollow | concentric |
| shape of the bumps | circle | | | | | circle | circle |
| cross-sectional | 1.0 | 1.0 | 1.0 | 1.0 | 1.0 | 1.0 | 1.0 |
| diameter of the | | | | | | | |
| bumps (mm) | | | | | | | |
| height of the | 0.1 | 0.1 | 0.1 | 0.1 | 0.1 | 0.1 | 0.1 |
| bumps (mm) | | | | | | | |
| width of the air- | 0.2 | 0.2 | 0.2 | 0.2 | 0.2 | 0.2 | 0.2 |
| leaving channel (mm) | | | | | | | |
| shear force (g/mm) | 56 | 42 | 45 | 60 | 71 | 62 | 74 |
| | 15th | 16th | 17th | 18th | 19th | 20th | 21st |
| | example | example | example | example | example | example | example |
| cross-sectional | solid | rectangle | cross | rhombus | hexagon | hollow | concentric |
| shape of the bumps | circle | | | | | circle | circle |
| cross-sectional | 3.0 | 3.0 | 3.0 | 3.0 | 3.0 | 3.0 | 3.0 |
| diameter of the | | | | | | | |
| bumps (mm) | | | | | | | |
| height of the | 0.3 | 0.3 | 0.3 | 0.3 | 0.3 | 0.3 | 0.3 |
| bumps (mm) | | | | | | | |
| width of the air- | 1.5 | 1.5 | 1.5 | 1.5 | 1.5 | 1.5 | 1.5 |
| leaving channel (mm) | | | | | | | |
| shear force (g/mm) | 154 | 111 | 115 | 173 | 188 | 174 | 198 |

It should be noted that the cross-sectional shape of the bumps in the 8th example to the 21st example and the cross-sectional shape of the bumps in the 1st example to the 7th example are the same or similar, respectively. The differences thereof are the size of the bumps and the distance of the bumps. Therefore, the bump structures in the 8th example to the 21st example of the present disclosure will not be repeated again herein.

Based on the aforementioned measurement results, it can be concluded that the deformation-controlling film of the present disclosure includes the specially adhering structure of the bumps and the air-leaving channel, sufficient shear force with the sheet can be generated regardless of the shapes of the bumps. Therefore, it is favorable for controlling the deformations of the sheet. In addition, the bumps of the deformation-controlling films in the 5th example, the 12th example and the 19th example are more densely arranged (as shown in FIG. 3E), and the shape of the bumps of the deformation-controlling films in the 6th example, the 7th example, the 13th example, the 14th example, the 20th example and the 21st example resembles a suction cup (as shown in FIG. 3F and FIG. 3G). Therefore, the deformation-controlling film in the aforementioned examples can generate bigger shear force, which can be suitable for the sheet with more severe warpage degree. Therefore, the size, the distance and the shape of the bumps of the deformation-controlling film of the present disclosure can be adjusted according to the requirements, thereby obtaining the most appropriate adhesion and support effects.

<Adhesion and Support Effects of Deformation-Controlling Film with Different Parameters>

The following paragraphs describe the measurement of the shear force, the peeling force, and the warpage suppression height of the deformation-controlling films in the 22nd example to the 40th example, so as to understand the adhesion effect between the deformation-controlling films and the sheets in the 22nd example to the 40th example. The shear force of this experiment is measured by pulling the deformation-controlling films and the sheets in opposite directions, the peeling force is measured by pulling the deformation-controlling films in a direction perpendicular to the sheets, and the warpage suppression height is determined by attaching the deformation-controlling films onto the sheets having a warpage degree of 100 mm, and then measuring the degree of the sheets returning to a flat state. The detail measurement results are shown in Table 2.

TABLE 2

| | 22nd | 23rd | 24th | 25th | 26th |
|---|---|---|---|---|---|
| | example | example | example | example | example |
| thickness of the | 50 | 500 | 1000 | 1500 | 3000 |
| deformation-controlling | | | | | |
| film (μm) | | | | | |
| contact area ratio (%) | 60 | 60 | 60 | 60 | 60 |
| Shore hardness of the | 15 A | 15 A | 15 A | 15 A | 15 A |
| deformation-controlling layer | | | | | |
| weight percentage of | 3 | 3 | 3 | 3 | 3 |
| the enhanced agent (%) | | | | | |
| ratio of vinyl in the | 4 | 4 | 4 | 4 | 4 |
| organopolysiloxane | | | | | |
| composition (%) | | | | | |
| cross-sectional shape | concentric | concentric | concentric | concentric | concentric |
| of the bumps | circle | circle | circle | circle | circle |
| shear force (g/mm) | 39 | 73 | 190 | 279 | 240 |
| peeling force (g/mm) | 1.4 | 0.8 | 2.4 | 2.2 | 2.0 |
| warpage suppression | 10.8 | 74.5 | 91.7 | 99.1 | 99.2 |
| height (mm) | | | | | |
| | 27th | 28th | 29th | 30th | 31st |
| | example | example | example | example | example |
| thickness of the | 5000 | 1500 | 1500 | 1500 | 1500 |
| deformation-controlling | | | | | |
| film (μm) | | | | | |
| contact area ratio (%) | 60 | 40 | 50 | 70 | 80 |
| Shore hardness of the | 15 A | 15 A | 15 A | 15 A | 15 A |
| deformation-controlling layer | | | | | |
| weight percentage of | 3 | 3 | 3 | 3 | 3 |
| the enhanced agent (%) | | | | | |
| ratio of vinyl in the | 4 | 4 | 4 | 4 | 4 |
| organopolysiloxane | | | | | |
| composition (%) | | | | | |
| cross-sectional shape | concentric | concentric | concentric | concentric | concentric |
| of the bumps | circle | circle | circle | circle | circle |
| shear force (g/mm) | 233 | 210 | 254 | 277 | 283 |
| peeling force (g/mm) | 3.7 | 0.9 | 1.9 | 2.9 | 3.2 |
| warpage suppression | 99.2 | 93.5 | 96.2 | 99.4 | 99.2 |
| height (mm) | | | | | |
| | 32nd | 33rd | 34th | 35th | 36th |
| | example | example | example | example | example |
| thickness of the | 1500 | 1500 | 1500 | 1500 | 1500 |
| deformation-controlling | | | | | |
| film (μm) | | | | | |
| contact area ratio (%) | 60 | 60 | 60 | 60 | 60 |
| Shore hardness of the | 5 A | 20 A | 50 A | 15 A | 15 A |
| deformation-controlling layer | | | | | |
| weight percentage of | 3 | 3 | 3 | 1 | 5 |
| the enhanced agent (%) | | | | | |
| ratio of vinyl in the | 4 | 4 | 4 | 4 | 4 |
| organopolysiloxane | | | | | |
| composition (%) | | | | | |
| cross-sectional shape | concentric | concentric | concentric | concentric | concentric |
| of the bumps | circle | circle | circle | circle | circle |
| shear force (g/mm) | 277 | 269 | 214 | 256 | 247 |
| peeling force (g/mm) | 3.5 | 2.3 | 0.4 | 2.8 | 1.8 |
| warpage suppression | 48.8 | 99.1 | 99.5 | 88.6 | 98.7 |
| height (mm) | | | | | |

| | 37th | 38th | 39th | 40th |
|---|---|---|---|---|
| | example | example | example | example |
| thickness of the | 1500 | 1500 | 1500 | 1500 |
| deformation-controlling | | | | |
| film (μm) | | | | |
| contact area ratio (%) | 60 | 60 | 60 | 60 |
| Shore hardness of the | 15 A | 15 A | 15 A | 15 A |
| deformation-controlling layer | | | | |
| weight percentage of | 8 | 3 | 3 | 3 |
| the enhanced agent (%) | | | | |
| ratio of vinyl in the | 4 | 0.5 | 1 | 5 |
| organopolysiloxane | | | | |
| composition (%) | | | | |
| cross-sectional shape | concentric | concentric | concentric | concentric |
| of the bumps | circle | circle | circle | circle |
| shear force (g/mm) | 266 | 238 | 253 | 277 |
| peeling force (g/mm) | 2.3 | 2.4 | 2.7 | 2.6 |
| warpage suppression | 97.9 | 92.3 | 97.4 | 99.0 |
| height (mm) | | | | |

Based on the aforementioned measurement results, it can be concluded that the method of controlling deformation of the sheet of the present disclosure adopted the deformation-controlling film, regardless of the thickness, contact area ratio, hardness and composition ratio of the deformation-controlling film, sufficient shear force with the sheet can be generated to control the deformation of the sheet, and possess the lower peeling force to prevent the deformation-controlling film from detaching from the sheet. From the measurement results in the 22nd example to the 27th example and the 32nd example to the 34th example, it can be understood that different the deformation-suppressing effects to the sheet can be generated by adjusting the thickness and the hardness of the deformation-controlling film. Therefore, the appropriate thickness and hardness of the deformation-controlling film can be selected according to the deformation statues of the sheet. In addition, from the measurement results in the 22nd example to the 40th example, it can be understood that the warpage suppression height of the sheet up to 100 mm can be suppressed by the deformation-controlling film. It proves the deformation-controlling film of the present disclosure has an excellent deformation-suppressing ability.

In summary, the deformation-controlling film and the method of controlling deformation of the sheet of the present disclosure include the deformation-controlling layer with the adhering structure. When the deformation-controlling layer is attached with the sheet, the adhering structure can help exhaust air, which makes the deformation-controlling layer and the sheet more inseparable, and improves the attached effect. The deformation-controlling layer has a specific supporting force which can suppress warpage or deformation force of the sheet. It is favorable for maintaining the flatness of the sheet. Moreover, after the deformation-controlling film of the present disclosure and the sheet directly attached to each other at room temperature, the deformation-controlling film and the sheet can be adhered well and provide temporary deformation-controlling effect without gluing, heating or vacuuming, and the deformation-controlling film can provide rigidity uniform force to support the sheet. It can minimize the stress on the sheet, make the sheet maintain the initial state, and reduce the problems of warping, splitting, edge chipping, etc. Furthermore, the deformation-controlling film in the present disclosure can support and shape after being attached, so it does not need to rely on a hard carrier for support. Furthermore, the deformation-controlling film in the present disclosure can be directly peeled off at room temperature and can be reused, which helps to simplify production steps, reduce costs, reduce material consumption, and improve manufacturing output and yield.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A deformation-controlling film, comprising:
a protective layer; and
a deformation-controlling layer connected to the protective layer, wherein a surface of the deformation-controlling layer away from the protective layer has an adhering structure;
wherein the adhering structure comprises a plurality of bumps, the plurality of bumps protrude from the surface of the deformation-controlling layer in a direction away from the protective layer, and an air-leaving channel is formed between adjacent two of the plurality of bumps.

2. The deformation-controlling film of claim 1, wherein a ratio between a thickness of the protective layer and a thickness of the deformation-controlling layer is 1:0.1 to 1:100.

3. The deformation-controlling film of claim 1, wherein a material of the protective layer is selected from a group consisting of polyimide and polyethylene naphthalate.

4. The deformation-controlling film of claim 1, wherein a thickness of the protective layer is 50 μm to 500 μm.

5. The deformation-controlling film of claim 1, wherein a thickness of the deformation-controlling layer is 50 μm to 5000 μm.

6. The deformation-controlling film of claim 1, wherein a material of the deformation-controlling layer comprises an organopolysiloxane composition, a cross-linking agent and an enhanced agent;
wherein based on a total weight of the deformation-controlling layer is 100%, a weight percentage of the organopolysiloxane composition in the deformation-controlling layer is 30% to 80%, a weight percentage of the cross-linking agent in the deformation-controlling layer is 18% to 60%, and a weight percentage of the enhanced agent in the deformation-controlling layer is 1% to 10%.

7. The deformation-controlling film of claim 6, wherein a monomer of the organopolysiloxane composition is selected from a group consisting of dimethoxydimethylsilane, triethoxyvinylsilane and trimethoxyphenylsilane.

8. The deformation-controlling film of claim 6, wherein the cross-linking agent is selected from a group consisting of benzoyl peroxide, 2,4-dichlorobenzoyl peroxide, dicumyl peroxide and 2,5-bis(tert-butylperoxy)-2,5-dimethylhexane.

9. The deformation-controlling film of claim 6, wherein the enhanced agent is selected from a group consisting of silicon dioxide and silicon carbide.

10. The deformation-controlling film of claim 1, wherein a Shore hardness of the deformation-controlling layer is 5 A to 50 A.

11. The deformation-controlling film of claim 1, wherein the plurality of bumps of the adhering structure are arranged in a staggered way.

12. The deformation-controlling film of claim 1, wherein a cross-sectional shape of each of the plurality of bumps is a solid circle, a rectangle, a cross, a rhombus, a hexagon, a hollow circle or a concentric circle.

13. The deformation-controlling film of claim 1, wherein a cross-sectional diameter of each of the plurality of bumps is 1.0 mm to 3.0 mm.

14. The deformation-controlling film of claim 1, wherein a height of each of the plurality of bumps is 0.1 mm to 0.3 mm.

15. The deformation-controlling film of claim 1, wherein a width of the air-leaving channel is 0.2 mm to 1.5 mm.

16. A method of controlling deformation of a sheet, comprising:
making a deformation-controlling film be contacted with the sheet; and
making a gas between the deformation-controlling film and the sheet be exhausted to form a temporary bonding, so as to control a warpage degree of the sheet;
wherein the deformation-controlling film comprises a protective layer and a deformation-controlling layer, the deformation-controlling layer is connected to the protective layer, a surface of the deformation-controlling layer away from the protective layer has an adhering structure, and the deformation-controlling film is contacted with the sheet by the adhering structure;
wherein the adhering structure comprises a plurality of bumps, the plurality of bumps protrude from the surface of the deformation-controlling layer in a direction away from the protective layer, an air-leaving channel is formed between adjacent two of the plurality of bumps, and the gas is exhausted by the air-leaving channel.

17. The method of controlling deformation of the sheet of claim 16, wherein the warpage degree of the sheet is 10 mm to 100 mm.

18. The method of controlling deformation of the sheet of claim 16, wherein a contact area ratio between the adhering structure and a surface of the sheet is 40% to 80%.

19. The method of controlling deformation of the sheet of claim 16, wherein a shear force between the deformation-controlling film and the sheet is 39 g/mm to 283 g/mm.

20. The method of controlling deformation of the sheet of claim 16, wherein a peeling force between the deformation-controlling film and the sheet is 0.4 g/mm to 3.7 g/mm.
